(19) United States
(12) Patent Application Publication
(10) Pub. No.: US 2024/0314410 A1
(43) Pub. Date: Sep. 19, 2024

(54) THERMAL IMAGING INCLUDING AN EXTENDED SHORT WAVE INFRARED LIGHT SOURCE

(71) Applicant: LightPath Technologies, Inc., Orlando, FL (US)

(72) Inventor: Shmuel RUBIN, Winter Park, FL (US)

(73) Assignee: LightPath Technologies, Inc., Orlando, FL (US)

(21) Appl. No.: 18/600,232

(22) Filed: Mar. 8, 2024

Related U.S. Application Data
(60) Provisional application No. 63/452,542, filed on Mar. 16, 2023.
(60) Provisional application No. 63/461,046, filed on Apr. 21, 2023.

(51) Int. Cl. H04N 23/20; G03B 15/06; H04N 23/56; H04N 23/695

(52) U.S. Cl. CPC H04N 23/20; G03B 15/06; H04N 23/56; H04N 23/695; G03B 2215/0585

(57) ABSTRACT

An infrared imaging system includes a detector configured to detect wavelengths in a first infrared wavelength band and a second infrared wavelength band, shorter than the first infrared wavelength band, wherein the second infrared wavelength band is an extended short wavelength infrared band; and a light source configured to output light in the second infrared wavelength band to an object radiating the first infrared wavelength.

The present application claims priority to Provisional Ser. No. 63/452,542 filed on Mar. 16, 2023, and Provisional Ser. No. 63/461,046 filed on Apr. 21, 2023, the entire contents of both of which are incorporated herein by reference.

### BACKGROUND

### Field

The present disclosure relates to thermal imaging, more particularly to thermal imaging using an extended short wave infrared light source having a wavelength lower than that of the thermal image to be captured.

### Description of the Related Art

Different infrared wavelength bands are used for different purposes. For example, infrared detectors include those for a near infrared (NIR) wavelength band (0.75 μm to 1.4 μm), for a short wavelength infrared (SWIR) wavelength band (1.4 to 3 μm), for a mid wavelength infrared (MWIR) wavelength band (3.0 to 5.0 μm) is, and for a long wavelength infrared (LWIR) wavelength band (8.0 to 12 μm) is. Typically, SWIR imaging systems image in the wavelength band of 1.4 to 2.0 μm and extended SWIR (eSWIR) imaging systems image in the wavelength band of 2.0 to 3.0 μm. In general, infrared imaging up to 2.5 μm images reflected light from a target and infrared imaging above 3.0 μm images emitted light from a target.

### SUMMARY

One or more embodiments is directed to an infrared imaging system, including a detector configured to detect wavelengths in a first infrared wavelength band and a second infrared wavelength band, shorter than the first infrared wavelength band, wherein the second infrared wavelength band is an extended short wavelength infrared band, and a light source configured to output light in the second infrared wavelength band to an object radiating the first infrared wavelength.

The light source may illuminate an entire field of view being imaged by the detector with the second infrared wavelength band.

The infrared imaging system may include a scanner to scan light output by the light source to illuminate a portion of the object being imaged by the detector.

The scanner may scan the light output by the light source to illuminate an entirety of the object simultaneously.

The scanner may scan the light output by the light source to illuminate subsets of the object sequentially.

The infrared imaging system may include a tracker to track the object based on the second infrared wavelength and the scanner may be configured to control scanning based on a position of the object.

The infrared imaging system may include a tuning circuit configured to control the light source to output a selected wavelength in the second infrared wavelength band.

The infrared imaging system may include a processing circuit configured to detect the selected wavelength reflected from a target in a scene being imaged by the detector and determine information from the target based on the reflected signal at the selected wavelength.

The light source may be further configured to output light in the first infrared wavelength band.

The light source may illuminate an entire field of view being imaged by the detector with the second infrared wavelength band.

The light source may illuminate less than the entire field of view being imaged by the detector with the second infrared wavelength band.

One or more embodiments may be directed to a method of detecting an infrared image, including providing a detector for detecting a thermal image of an object, the detector configured to detect wavelengths in a first infrared wavelength band, the detector having a field of view, illuminating at least a portion of the object with a second infrared wavelength band, shorter than the first infrared wavelength band, and detecting the first infrared wavelength band.

The second infrared wavelength band may be an extended short wavelength infrared band.

The first infrared wavelength band may be a long wave infrared wavelength band.

Illuminating the object may include scanning illumination across the object.

The method may include detecting the second infrared wavelength band.

The method may include illuminating a field of view of the detector with the second infrared wavelength band.

The method may include tuning to a selected wavelength in the second infrared wavelength band before illuminating at least the portion of the object.

One or more embodiments are directed to a method of obtaining information about a target based on infrared wavelengths associated with the target, the method including detecting a first infrared wavelength band emitted from a target, and detecting a second infrared wavelength band, shorter than the first infrared wavelength band, wherein the second infrared wavelength band is an extended short wavelength infrared band, that is output from or reflected by the target.

The method may include illuminating the target with light in the second infrared wavelength band.

Illuminating the target with light in the second infrared wavelength band includes controlling the light to have a selected wavelength.

Detecting the second infrared wavelength band may include receiving the second infrared wavelength band output from a source associated with the target.

### BRIEF DESCRIPTION OF THE DRAWINGS

FIG. 1 illustrates a schematic side view of an imaging system according to an embodiment.

FIG. 2 illustrates a schematic side view of an imaging system according to an embodiment.

FIG. 3 illustrates use of the imaging system according to FIG. 1 or FIG. 2 with a target.

FIG. 4 illustrates a spectral response of a camera for use in the imaging system.

FIG. 5 is an output of the camera in the imaging system in which the reflected light and the thermal image are imaged at the same time.

FIG. 6 illustrates use of an imaging system according to an embodiment with a target.

FIG. 7 illustrates use of an imaging system according to an embodiment with a target.

FIG. 8 illustrates use of an imaging system according to an embodiment with a target.

The scope of the present disclosure is best understood from the following detailed description of exemplary embodiments when read in conjunction with the accompanying drawings.

### DETAILED DESCRIPTION

Using a targeting illumination for MWIR or LWIR imaging is typically not be effective, given the poor reflectance at these wavelengths. However, in accordance with embodiments, by using a camera that can detect in both the MWIR or LWIR and the eSWIR wavelength bands, targeting of such higher wavelength band systems may be realized. In other words, an imaging system according to embodiments may be used to image both emissive heat and reflected light.

Further, current wavelengths used for a beacon on a target require the use of a cooled camera to detect them. Additionally, current wavelengths used as designators, i.e., illuminating the target with illumination spaced from the camera, can be readily detected by other cameras, i.e., not unique to a particular camera.

Thus, embodiments are directed to using illumination that can be reflected by or indicative of the target, that is readable by thermal imaging systems having a particular spectral response, but not readily detected by other thermal imaging systems and is outside the spectral region to be used to detect the thermal image.

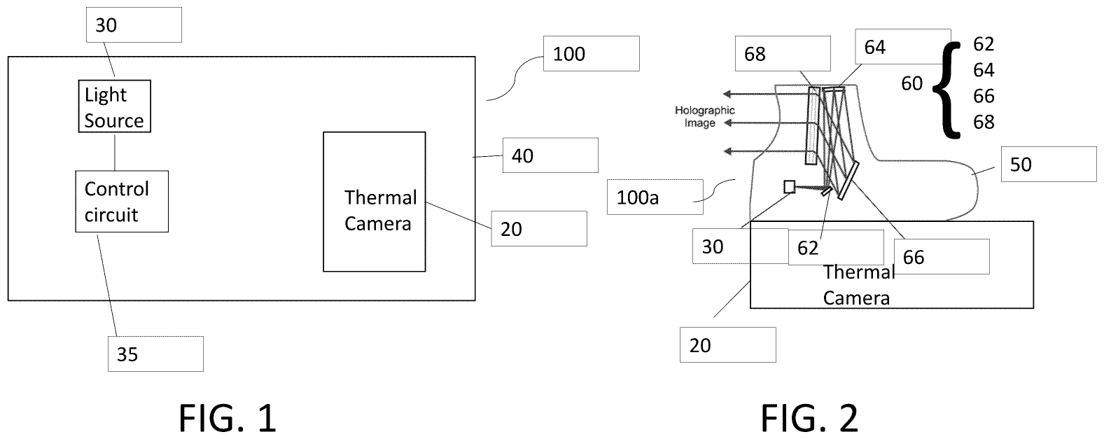

As shown in FIG. 1, an imaging system 100 according to an embodiment includes a broadband thermal camera 20 for detection in the LWIR (and/or MWIR) and eSWIR range and a light source 30 that emits light in the eSWIR range. As a particular example of such a broadband thermal camera 20 includes an uncooled LWIR bolometer manufactured by LightPath Technologies®, e.g., the Multispectral Infrared Camera MANTIS™.

A control circuit 35 for controlling the light source may be used to control illumination of light output by the light source 30 to illuminate a portion of a target to be imaged by the camera 20. The control circuit 35 may scan the light output by the light source 30 to illuminate an entirety of entirety of a field of view of the camera 20 or may scan the light output by the light source 30 to illuminate subsets of the object sequentially. Alternatively or additionally, the control circuit 35 may control scanning based on a position of the object. Alternatively or additionally, the control circuit 35 may control a wavelength to be output by the light source 30 and/or an intensity to be output by the light source 30 to pulse the light output by the light source 30. The control circuit may also be in communication with the camera 20 to synchronize detection of the light with the output of the light source 30. The control circuit 35 may be provided in the housing 40, incorporated with the thermal camera 20, or remote therefrom but in communication with the light source 30 and/or the camera 20.

The imaging system 100 illustrates that the camera 20 and the light source 30 are integrated in a single housing 40. Alternatively, as shown in FIG. 2, an imaging system 100a may include the light source 30 in a separate housing 50 from the thermal camera 20 and may include additional optics 60 to generate a holographic image to be reflected from a target. For example, the optics 60 may include a first mirror 62 to direct light from the light source 30 to a collimating reflector 64, which collimates light onto a holographic grating 66, which reflects light onto a reticle image hologram 68 to output the holographic images. The optics 60 may also be included in the housing 40. Such holographic sights are known, e.g., in U.S. Pat. No. 6,490,060 B1, which is hereby incorporated by reference in its entirety for all purposes. Again, the control circuit 35 may be provided in the housing 50, incorporated with the thermal camera 20, or remote therefrom, but in communication with, the light source 30.

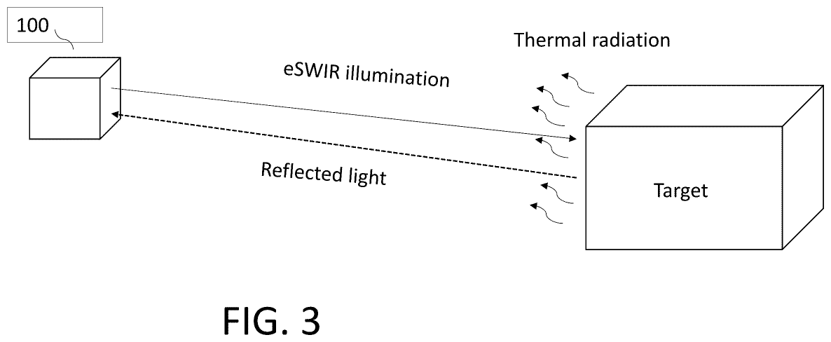

When serving as a sight, e.g., on a gun, the light source 30 is collimated and aligned together with the camera 20 so that the light source can be used to target the gun, while seeing the laser spot reflected together with the thermal image. An example of using either configuration is shown in FIG. 3. As may be seen therein, the imaging system 100 (or 100a) illuminates a target with eSWIR illumination output from the light source 30, as indicated by the solid line. This eSWIR illumination is reflected by the target back to the imaging system 100, as indicated by the dashed line. The imaging system 100 also images the thermal image from the target, as indicated by the wavy lines.

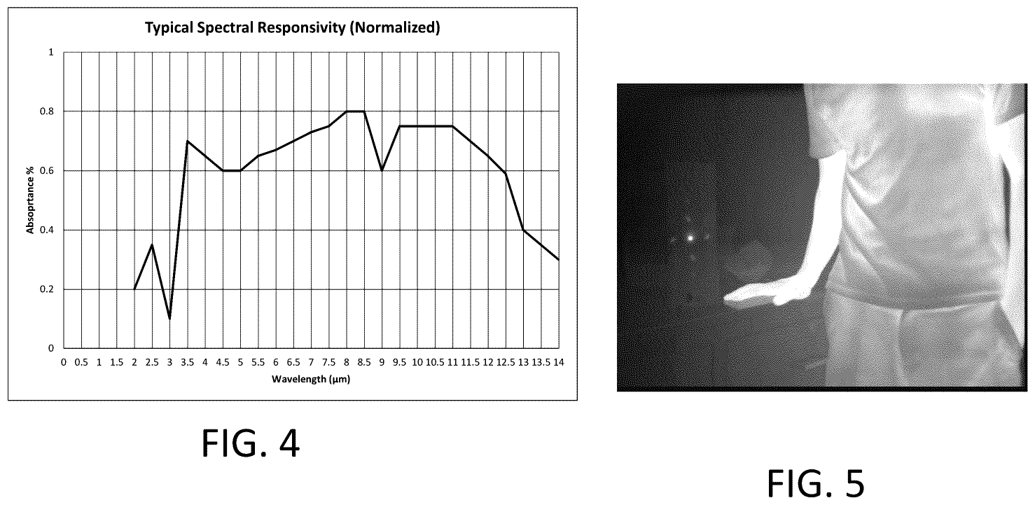

The exact wavelength to be output by the light source 30 depends on the spectral response of the camera 20. For example, the Multispectral Infrared Camera MANTIS™ has a spectral response as shown in FIG. 4. As may be seen therein, in the eSWIR region, this particular camera has a peak response around 2.3 μm. Response shown in FIG. 4 is a typical spectral response, however, peak wavelengths may vary+/−0.5 μm. Therefore, a light source 30 outputting this wavelength may be used in conjunction with this particular camera 20. The light source 30 may be a gallium antimonide (GaSb) laser. Alternatively or additionally, the light source 30 may be a high power light source emitting light in the range of 2-3 μm to illuminate the environment surrounding the target such that a dual band or multispectral detector can image both the light reflected from the surrounding environment and the thermal image.

As may be seen in FIG. 5, when such a laser is used as the light source 30 with this particular camera 20, the camera 20 may detect both a thermal image and the reflected light at the same time.

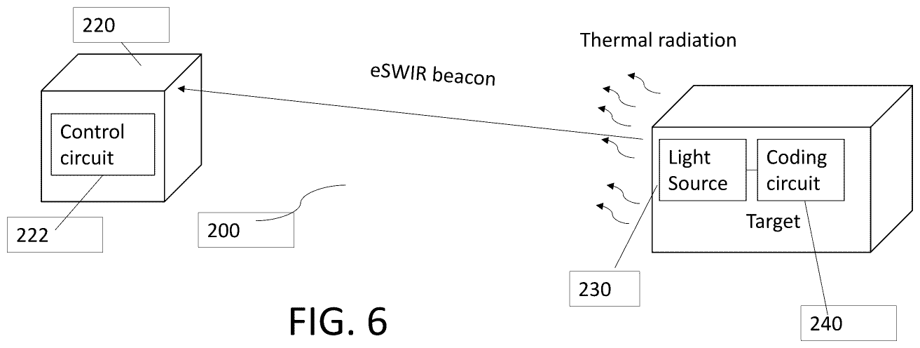

In another embodiment, an imaging system 200 includes a thermal camera 220 and a light source 230 that are not at a same location. In particular, as may be seen in FIG. 6, instead of the target being illuminated by a light source in the imaging system, the light source 230 is incorporated in or attached to the target to serve as a beacon for the thermal camera 220. Further, a coding circuit 240 may be provided in communication with the light source 230, e.g., on the target or remote therefrom. The coding circuit may control timing, intensity, and/or wavelength of light output from the light source 330 to encode information in the light. The thermal camera 220 may also include a decoding circuit 222 to decode any modulation or changes in power of the laser, to identify a message or a code delivered through said modulation of the laser 230. Again, the decoding circuit 222 may be part of the thermal camera or remote therefrom.

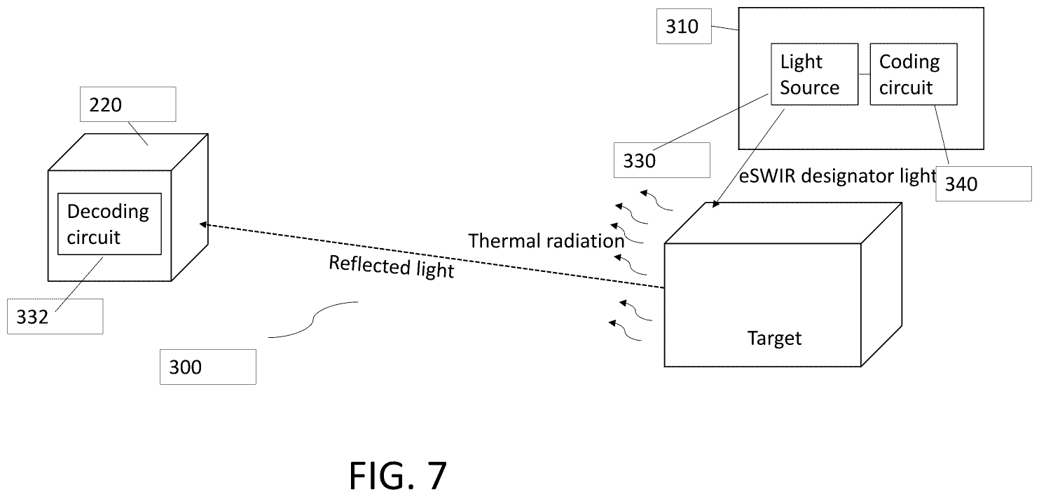

In yet another embodiment, an imaging system 300 includes the thermal camera 220 and a light source 330 that again are not at a same location as each other or as a target. In particular, as may be seen in FIG. 7, again, instead of light source being on camera 200, the light source 330 is incorporated in or attached to a device 310, e.g., a device worn by or carried by a person, a vehicle, e.g., an unmanned aerial vehicle, and so forth, different from the target, to serve as a laser designator to illuminate the target. In other words, the light source 330 is at a location separate from both the camera 320 and the target, e.g., a person may illuminate the target for detection by a thermal camera remote from the person, e.g., in a vehicle or used by another person, or the light source may be in a vehicle to light up the target for the detection by one or more thermal cameras not on the vehicle. Further, a coding circuit 340 may be provided in communication with the light source 330, e.g., on the device 310 or remote therefrom. The thermal camera 220 may also include a decoding circuit 222 to decode any modulation or changes in power of the laser, to identify a message or a code delivered through said modulation of the laser 330. Again, the decoding circuit 222 may be part of the thermal camera or remote therefrom.

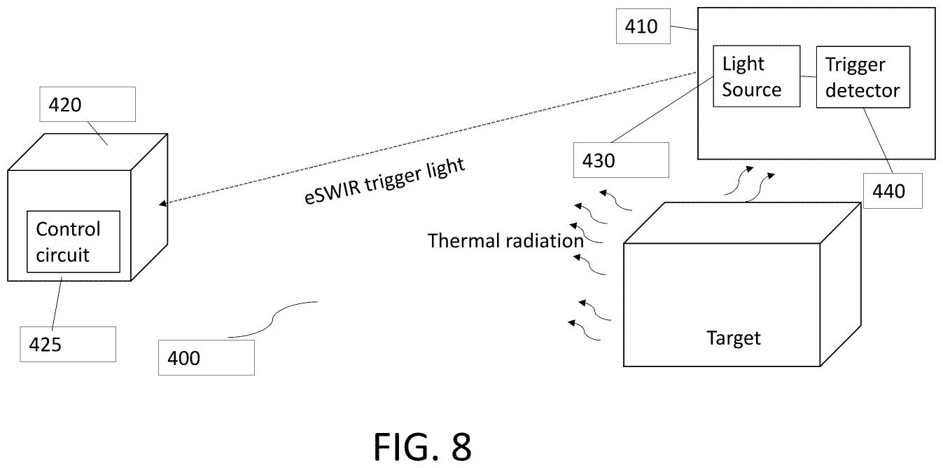

In another embodiment shown in FIG. 8, an imaging system 300 includes a thermal camera 420 and a trigger device 410 positioned at a particular, predetermined location, i.e., may not be mobile, may include a light source 430 and a trigger detector 440, In particular, the light source 43 may emit eSWIR light in response to a trigger, e.g., a motion detection or thermal response exceeding a predetermined limit, detected by the trigger detector 450. Thus, the eSWIR light from the light source 430 can be detected by the camera 420 and used to let the camera 420 know where to be directed. The camera 420 may or may not include the light source 430 and may include a control circuit 422 to zoom or pan the camera 420 based on the eSWIR trigger signal from the trigger device 410. Additionally or alternatively, the trigger detector 440 may be included in the device 310 to further cause the light source 330 to output eSWIR designator light to a target.

In a modification, light sources 30, 230, 330, and/or 430 may be provided in conjunction with others of these light sources.

The present disclosure is not limited to only the above-described embodiments, which are merely exemplary. It will be appreciated by those skilled in the art that the disclosed systems and/or methods can be embodied in other specific forms without departing from the spirit of the disclosure or essential characteristics thereof. In some instances, as would be apparent to one of skill in the art as of the filing of the present application, features, characteristics, and/or elements described in connection with a particular embodiment may be used singly or in combination with features, characteristics, and/or elements described in connection with other embodiments unless otherwise indicated. The presently disclosed embodiments are therefore considered to be illustrative and not restrictive. The disclosure is not exhaustive and should not be interpreted as limiting the claimed invention to the specific disclosed embodiments. In view of the present disclosure, one of skill in the art will understand that modifications and variations are possible in light of the above teachings or may be acquired from practicing of the disclosure. The scope of the invention is indicated by the appended claims, rather than the foregoing description.

1. An infrared imaging system, comprising:
a detector configured to detect wavelengths in a first infrared wavelength band and a second infrared wavelength band, shorter than the first infrared wavelength band, wherein the second infrared wavelength band is an extended short wavelength infrared band; and
a light source configured to output light in the second infrared wavelength band to an object radiating the first infrared wavelength.

2. The infrared imaging system of claim 1, wherein the light source illuminates an entire field of view being imaged by the detector with the second infrared wavelength band.

3. The infrared imaging system of claim 1, further comprising a scanner to scan light output by the light source to illuminate a portion of the object being imaged by the detector.

4. The infrared imaging system of claim 3, wherein the scanner is to scan the light output by the light source to illuminate an entirety of the object simultaneously.

5. The infrared imaging system of claim 3, wherein the scanner is to scan the light output by the light source to illuminate subsets of the object sequentially.

6. The infrared imaging system of claim 3, further comprising a tracker to track the object based on the second infrared wavelength and the scanner is configured to control scanning based on a position of the object.

7. The infrared imaging system of claim 1, further comprising a tuning circuit configured to control the light source to output a selected wavelength in the second infrared wavelength band.

8. The infrared imaging system of claim 7, further comprising a processing circuit configured to detect the selected wavelength reflected from a target in a scene being imaged by the detector and determine information from the target based on the reflected signal at the selected wavelength.

9. The infrared imaging system of claim 1, wherein the light source is further configured to output light in the first infrared wavelength band.

10. The infrared imaging system of claim 9, wherein the light source illuminates an entire field of view being imaged by the detector with the second infrared wavelength band.

11. The infrared imaging system of claim 10, wherein the light source illuminates less than the entire field of view being imaged by the detector with the second infrared wavelength band.

12. A method of detecting an infrared image, comprising:
providing a detector for detecting a thermal image of an object, the detector configured to detect wavelengths in a first infrared wavelength band, the detector having a field of view;
illuminating at least a portion of the object with a second infrared wavelength band, shorter than the first infrared wavelength band; and
detecting the first infrared wavelength band.

13. The method of claim 12, wherein the second infrared wavelength band is an extended short wavelength infrared band.

14. The method of claim 13, wherein the first infrared wavelength band is a long wave infrared wavelength band.

15. The method of claim 12, wherein illuminating the object includes scanning illumination across the object.

16. The method of claim 12, further comprising detecting the second infrared wavelength band.

17. The method of claim 12, further comprising illuminating a field of view of the detector with the second infrared wavelength band.

18. The method of claim 12, further comprising tuning to a selected wavelength in the second infrared wavelength band before illuminating at least the portion of the object.

19. A method of obtaining information about a target based on infrared wavelengths associated with the target, the method comprising:
detecting a first infrared wavelength band emitted from a target; and
detecting a second infrared wavelength band, shorter than the first infrared wavelength band, wherein the second infrared wavelength band is an extended short wavelength infrared band, that is output from or reflected by the target.

20. The method of claim 19, further comprising illuminating the target with light in the second infrared wavelength band.

21. The method of claim 20, wherein illuminating the target with light in the second infrared wavelength band includes controlling the light to have a selected wavelength.

22. The method of claim 19, wherein detecting the second infrared wavelength band includes receiving the second infrared wavelength band output from a source associated with the target.
